(19) United States
(12) Patent Application Publication
(10) Pub. No.: US 2009/0248190 A1
(43) Pub. Date: Oct. 1, 2009

(54) Portable modular manufacturing system

(76) Inventor: John M. Spangler, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/078,339

(22) Filed: Mar. 28, 2008

(51) Int. Cl. B65G 43/00; B65G 21/10

(52) U.S. Cl. 700/112; 198/860.2; 198/861.1

(57) ABSTRACT

A modular manufacturing station is provided. The modular manufacturing station has plurality of beams forming a skeleton and an article transportation system. The article transportation system is configured to transport one or more articles through the manufacturing station at a speed selected from a plurality of speeds and at a height selected from a plurality of heights. The modular manufacturing station also has at least one utility connection for receiving external utilities and at least one piece of manufacturing equipment. The modular manufacturing station further has a controller configured to regulate the speed and height at which articles are transported through the modular manufacturing station and regulate the operation of the manufacturing equipment.

### TECHNICAL FIELD

The present disclosure is directed to a manufacturing system, and more particularly, to a modular manufacturing system having portable capabilities.

### BACKGROUND

A finished product is typically manufactured in steps, through the use of individual manufacturing stations having machines or system parts that are specifically constructed for a specialized purpose. These individual manufacturing stations are linked together to form a manufacturing chain, through which each product being produced is advanced. Such manufacturing chains are often large structures permanently situated inside a manufacturing facility.

Because of their large sizes and permanency, conventional manufacturing chains are usually inflexible and are only cost-effective for the production of one type of finished product. If a design or product falls out of favor with the market, the manufacturing chain must be modified to produce a new finished product or design. When this happens, those manufacturing stations originally designed to be permanent fixtures in the manufacturing chain must be modified, removed, or replaced, which can be an expensive and time-consuming process.

U.S. Pat. No. 7,076,865 issued to Morbitzer et al. (Morbitzer) on Jul. 18, 2006, discloses a manufacturing chain having portable process modules with substantially identical base structures. Each module has one or more associated magazine units containing various components used to assemble a finished article. Such components are situated in stacked configuration. In addition, the components are transferred between modules by moving the magazine units from module to module. Furthermore, each module has a transport device such as a wheel to allow each module to be relocated and/or replaced by another module.

Although the manufacturing chain in Morbitzer may be more flexible than a conventional permanent manufacturing chain, the flexibility of the chain may be limited. In particular, the manufacturing chain of Morbitzer relies on relocatable magazine units that are separate from the module structures for transporting the assembly components between modules. Some applications may not be conducive to utilizing such a component transport system. For example, if painted components were stacked on top of each other in a similar manner as that disclosed in Morbitzer, the quality of the coating applied to the surfaces of each component may be compromised. In addition, due to the fixed sizes and shapes of the magazine units, it may be difficult to transport components having sizes and shapes that conflict with the magazine unit sizes and shapes, thereby limiting the types of articles that may be assembled by the manufacturing chain.

The disclosed manufacturing system is directed to overcoming one or more of the problems set forth above.

### SUMMARY

In one aspect, the present disclosure is directed toward a modular manufacturing station. The modular manufacturing station includes plurality of beams forming a skeleton and an article transportation system. The article transportation system is configured to transport one or more articles through the manufacturing station at a speed selected from a plurality of speeds and at a height selected from a plurality of heights. The modular manufacturing station also includes at least one utility connection for receiving external utilities and at least one piece of manufacturing equipment. The modular manufacturing station further includes a controller configured to regulate the speed and height at which articles are transported through the modular manufacturing station and regulate the operation of the manufacturing equipment.

Consistent with a further aspect of the disclosure, a method is provided for operating an article transportation system of a modular manufacturing station. The method includes selecting a height at which articles are transported through the modular manufacturing station from a plurality of heights and adjusting the height of the article transportation system so that articles are transported through the modular manufacturing station at substantially the same height as the selected height. The method also includes selecting a speed at which articles are transported through the modular manufacturing station from a plurality of speeds and adjusting the speed of the article transportation system so that articles are transported through the modular manufacturing station at substantially the same speed as the selected speed.

### BRIEF DESCRIPTION OF THE DRAWINGS

FIG. 1 is a diagrammatic illustration of a manufacturing chain according to an exemplary disclosed embodiment;

FIG. 2 is a diagrammatic representation of a modular frame and conveyor system utilized by the modules of the manufacturing chain according to an exemplary disclosed embodiment;

FIG. 3 is a diagrammatic representation of the conveyor system of FIG. 2 according to an exemplary disclosed embodiment;

FIG. 4 is another diagrammatic representation of the conveyor system of FIG. 2 according to an exemplary disclosed embodiment;

FIG. 5 is a schematic representation of an exemplary hydraulic control system utilized by the modular frame and conveyor system of FIG. 2;

FIG. 6 is a schematic representation of an exemplary electric motor control system utilized by the modular frame and conveyor system of FIG. 2; and

FIG. 7 is a schematic representation of a control system utilized by the manufacturing chain of FIG. 1.

### DETAILED DESCRIPTION

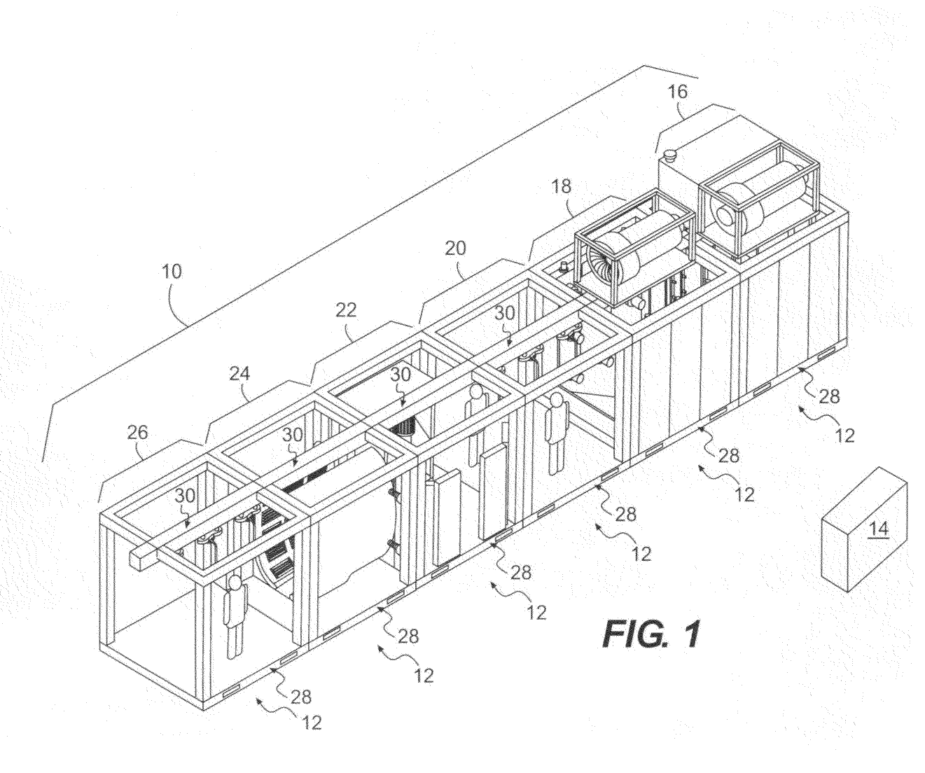

FIG. 1 provides a diagrammatic perspective of a manufacturing chain 10 according to an exemplary embodiment. Manufacturing chain 10 may be used to perform a manufacturing process such as, for example, powder coating an article and may include several modular manufacturing units 12 and a control system 14 for performing the manufacturing task. Manufacturing units 12 may include, for example, a washer module 16, a blow off module 18, an inspection module 20, a powder coat module 22, an oven module 24, and an unload module 26. It should be understood that while manufacturing chain 10 is illustrated as a powder coating system, manufacturing chain 10 may be any type of manufacturing system requiring one or more modular manufacturing units. For example, manufacturing chain 10 may embody an engine block assembly line, a brake assembly line, or any other manufacturing system known in the art. Furthermore, it is contemplated that although FIG. 1 discloses utilizing six modular manufacturing units 12, a fewer or greater number of modular manufacturing units 12 may alternatively be used. Also, more than one modular manufacturing unit 12 of a particular type may be employed within the same chain, if desired.

Each modular manufacturing unit 12 may be a specialized manufacturing station containing all equipment necessary to accomplish a particular manufacturing task within a self-contained vessel and may combine with other modular manufacturing units 12 to perform more complicated manufacturing tasks. In addition, the self-contained characteristic of each modular manufacturing unit 12 may allow a particular modular manufacturing unit 12 to be readily moved wherever it is needed. Furthermore, each modular manufacturing unit 12 may be interchanged with other modular manufacturing units 12 of a manufacturing chain 10. Modular manufacturing units 12 may each have a frame 28 providing structural support and a conveyor system 30 for conveying articles through manufacturing chain 10. It is contemplated that each frame 28 may have universal features that may be utilized by all types of modules, as needed. In addition, each conveyor system 30 may be operationally connected to other conveyor systems 30 of adjacent modular manufacturing units 12 situated within manufacturing chain 10 so that once an article exits a particular modular manufacturing unit 12, the conveyor system 30 of an adjacent modular manufacturing unit 12 may continue the transportation of the article through manufacturing chain 10.

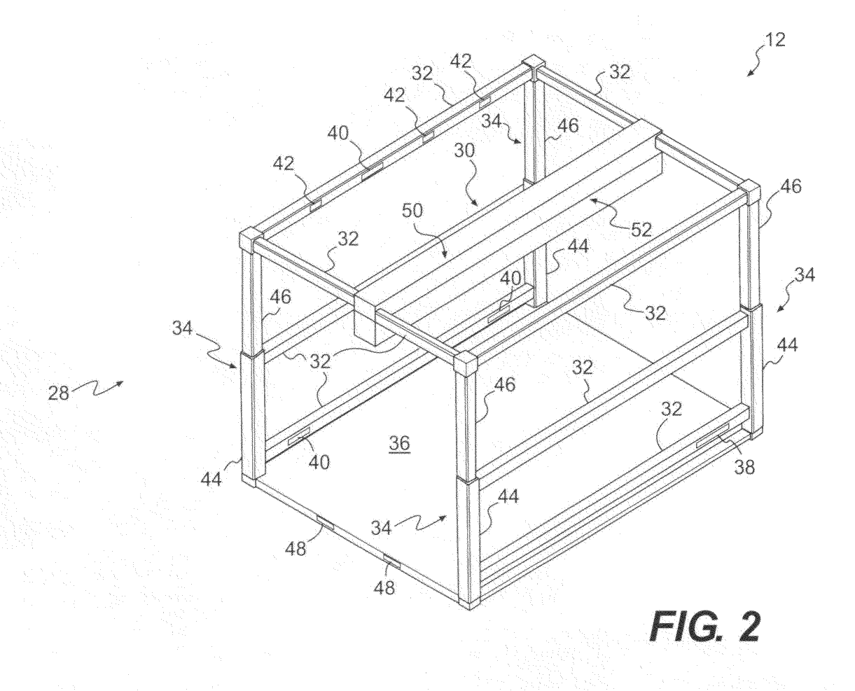

FIG. 2 provides a diagrammatic perspective of frame 28 according to an exemplary embodiment. Frame 28 may include a plurality of fixed and adjustable support beams 32, 34 for supporting manufacturing equipment such as, for example, a washer or a paint applicator. Frame 28 may also include a platform 36 and a utility source 38 for providing utilities (e.g., electricity, water, air, etc.) to the associated modular manufacturing unit 12.

Fixed and adjustable support beams 32, 34 may form an exterior skeleton to which all other elements of modular manufacturing unit 12 may be attached, and may be fabricated from steel, carbon composites, or any other material known in the art suitable for supporting the manufacturing module. Fixed and adjustable support beams 32, 34 may include mounting devices 40 and utilities connections 42. Mounting devices 40 may be, for example, hooks, latches, sockets, or any other device capable of supporting manufacturing equipment to be mounted on fixed and adjustable support beams 32, 34. Mounting devices 40 may interact with corresponding hooks, latches, and sockets located on the manufacturing equipment to support the equipment. In addition, utilities connections 42 may provide such utilities as, for example, electrical power, water, compressed air, gas, or any other utility needed for the operation of the manufacturing equipment. Utility connections 42 may embody electrical outlets, quick connect interfaces, or any other utility interface capable of engaging the manufacturing equipment.

Unlike fixed support beams 32, adjustable support beams 34 may include a hollow tubular portion 44 and a piston portion 46. Piston portion 46 may be slidably received within tubular portion 44, thereby increasing or decreasing the length of adjustable support beams 34. It is contemplated that piston portion 46 may be hydraulically, pneumatically, or mechanically moved and locked into place in relation to tubular portion 44 at specified lengths.

The manipulation of adjustable support beams 34 may at least partially control the height at which articles may be conveyed through modular manufacturing unit 12. As is illustrated in FIG. 2, conveyor system 30 may be connected to an upper portion of frame 28. Therefore expanding adjustable support beams 34 may increase the height at which articles may be conveyed through modular manufacturing unit 12. In addition, contracting adjustable support beams 34 may decrease the height at which articles may be conveyed through modular manufacturing unit 12. It is contemplated that adjustable support beams 34 at one end of modular manufacturing unit 12 may be set at a particular length while adjustable support beams 34 at the other end of modular manufacturing unit 12 may be set to another length. This may cause the height of an article being conveyed to change as the article travels through modular manufacturing unit 12.

Although fixed and adjustable support beams 32, 34 are illustrated as forming a cubic shape, fixed and adjustable support beams 32, 34 may be positioned to form any shape conducive to the production of a finished article. Additionally, the number of fixed and adjustable support beams 32, 34 utilized to form the exterior skeleton may vary depending upon the shape of the frame. Fixed and adjustable support beams 32, 34 may be secured together by mechanical fasteners, welds, or any other devices known in the art that are used to secure components.

Platform 36 may include engagement holes 48 for interaction with transportation vehicles such as forklifts. Engagement holes 48 may facilitate the relocation of the module to any location desired. In an alternate embodiment, platform 36 may include castors, a sled, or any other device that may facilitate the relocation of frame 28 and the associated modular manufacturing unit 12.

Utility source 38 may supply the utilities to connections 42 via wires and/or tubes (not shown) running along an interior of fixed support beams 32 and/or an exterior of adjustable support beams 34. Utility source 38 may be disposed at any location convenient for receiving utilities from an outside source. Such outside sources may include, for example, a facility electrical power grid (not shown), a battery (not shown), a compressed air tank, and/or a water supply. It is contemplated that electrical power, compressed air, and/or water may be supplied to an initial module in a manufacturing chain, with the other modules receiving the utilities from the initial module, if desired.

Conveyor system 30 may traverse the length of modular manufacturing unit 12 and may include a structural portion 50 and a conveyor portion 52. Structural portion 50 may be connected to frame 28 and may support conveyor portion 52 and articles that may be conveyed by conveyor portion 52. In addition, conveyor portion 52 may transport articles from one end of modular manufacturing unit 12 to the other.

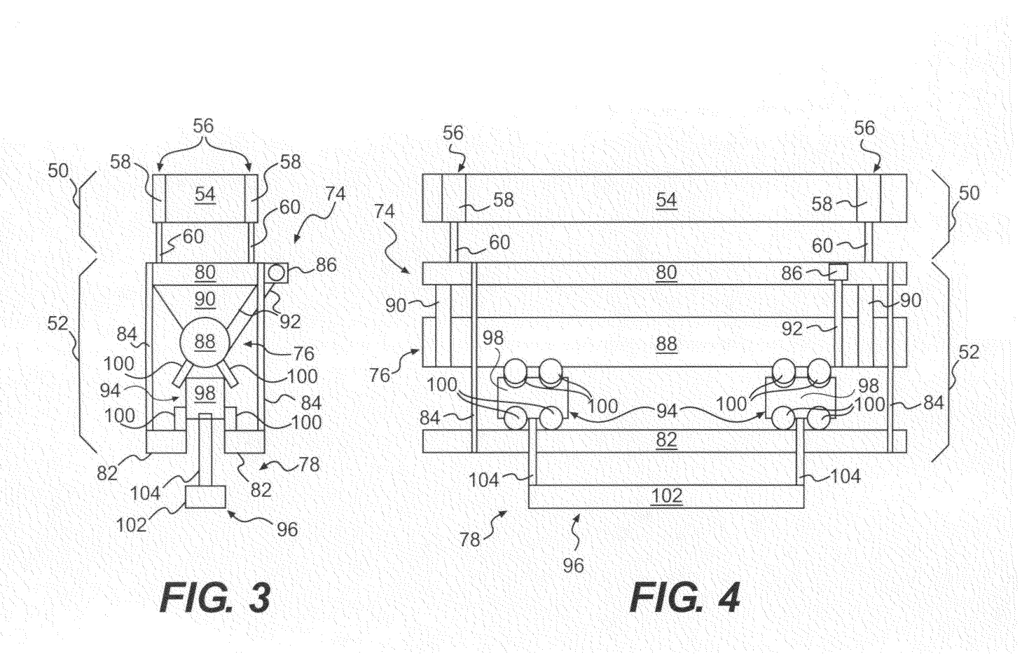

As illustrated in FIGS. 3 and 4 structural portion 50 may include a beam 54. Beam 54 may bear the weight of the entire conveyor system 30 and may be secured to frame 28 via any device such as, for example, welds, mechanical fasteners, or any other devices capable of adequately securing beam 54 to frame 28. In addition, beam 54 may be fabricated from steel, carbon composites, or any other material known in the art suitable for supporting conveyor portion 52 and any articles being transported by conveyor portion 52.

Structural portion 50 may also include a plurality of adjustable devices 56. Each adjustable device 56 may include a hollow tubular portion 58 and a piston portion 60 that may be slidably received within tubular portion 58. Such sliding movement of the piston portion 60 may increase and decrease the length of adjustable device 56. It is contemplated that piston portion 60 may be hydraulically, mechanically, or pneumatically moved and locked into place in relation to tubular portion 58 at specified lengths.

Adjustable devices 56 (in conjunction with adjustable support beams 34) may control the height at which articles may be conveyed through modular manufacturing unit 12. Tubular portion 58 may be secured to beam 54, and piston portion 60 may be secured to conveyor portion 52 so that, when adjustable devices 56 are contracted the space between beam 54 and conveyor portion 52 may be decreased, thereby raising the height at which articles may be conveyed through modular manufacturing unit 12. In addition, when adjustable devices 56 are expanded the space between beam 54 and conveyor portion 52 may be increased, thereby lowering the height at which articles may be conveyed through modular manufacturing unit 12. It is contemplated that adjustable devices 56 at one end of modular manufacturing unit 12 may be set to a particular length while adjustable devices 56 at the other end of modular manufacturing unit 12 may be set to another length. This may cause the height of an article being conveyed to change as the article travels through modular manufacturing unit 12.

It is contemplated that adjustable support beams 34 may be replaced with fixed support beams 32 and/or adjustable devices 56 may be omitted. In embodiments replacing adjustable support beams 34 with fixed support beams 32, only the expansion and contraction of adjustable devices 56 may regulate the height at which articles may be conveyed through modular manufacturing unit 12. In addition, in embodiments omitting adjustable devices 56, conveyor portion 52 may be directly secured to beam 54 and only the expansion and contraction of adjustable devices 56 may regulate the height at which articles may be conveyed through modular manufacturing unit 12. Furthermore, in embodiments replacing adjustable support beams 34 with fixed support beams 32 and omitting adjustable devices 56, the height at which articles may be conveyed through modular manufacturing unit 12 may be fixed.

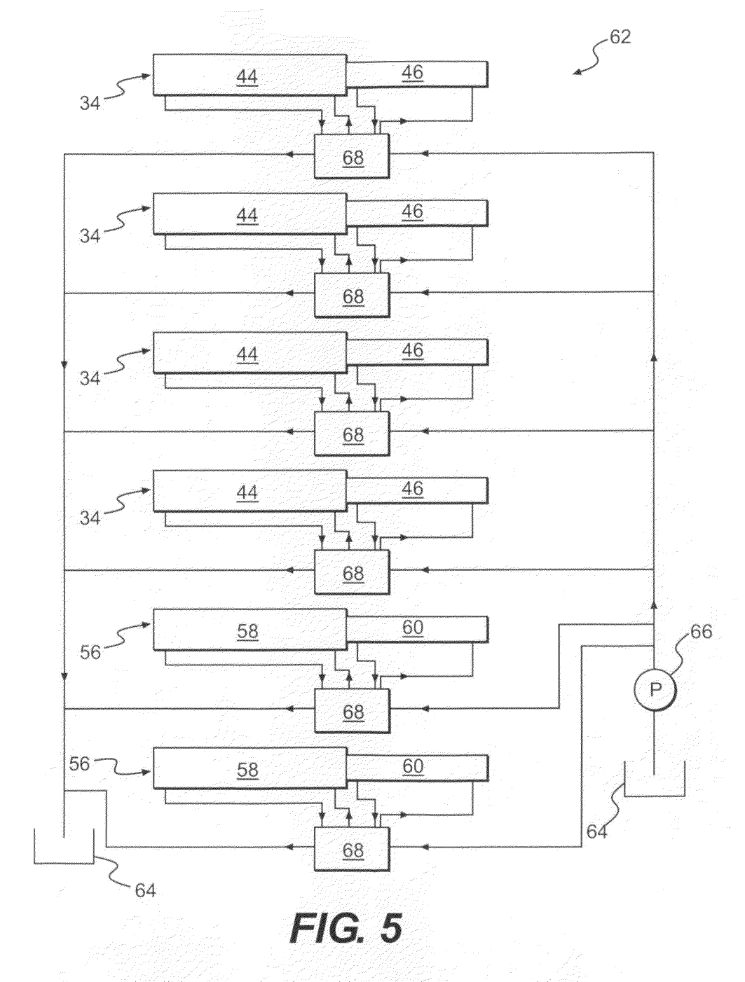

FIG. 5 illustrates an exemplary system 62 that may be used to raise and lower conveyor system 30. System 62 may be either a hydraulic a pneumatic system and may include a plurality of fluid or pneumatic components that cooperate together to manipulate adjustable support beams 34 and/or adjustable devices 56. Specifically, system 62 may include a tank 64 holding a supply of fluid and a source 66 for pressurizing and directing the fluid to one or more adjustable support beams 34 and/or adjustable devices 56.

In the exemplary embodiment, piston portions 46 of adjustable support beams 34 may be arranged within tubular portions 44 of adjustable support beams 34 to form two separate hydraulic or pneumatic chambers (not shown). It is contemplated that piston portions 46 and tubular portion 44 may form only one hydraulic or pneumatic chamber, if desired. The pressure chambers may be selectively supplied with and drained of a pressurized fluid from system 62 to cause piston portions 46 to displace within tubular portions 44, thereby changing the effective length of adjustable support beams 34.

Similar to adjustable support beams 34, piston portions 60 of adjustable devices 56 may be arranged within tubular portions 58 of adjustable devices 56 to form two separate hydraulic or pneumatic chambers (not shown). It is contemplated that piston portions 60 and tubular portion 58 may form only one hydraulic or pneumatic chamber, if desired. The pressure chambers may be selectively supplied with and drained of a pressurized fluid from system 62 to cause piston portions 60 to displace within tubular portions 58, thereby changing the effective length of adjustable devices 56.

Tank 64 may constitute a reservoir configured to hold a supply of fluid. The fluid may include, for example, a dedicated hydraulic oil, air, or any other fluid known in the art. It is contemplated that system 62 may be connected to multiple separate fluid tanks, if desired.

Source 66 may produce a flow of pressurized fluid. In embodiments utilizing a hydraulic system, source 66 may include a pump such as, for example, a variable displacement pump, a fixed displacement pump, a variable delivery pump, or any other source of pressurized fluid known in the art. Additionally, in embodiments utilizing a pneumatic system, source 66 may include an air compressor. Furthermore, source 66 may be directly powered by utility source 38 via electrical wires running along the interior of fixed support beams 32 and along the exterior of adjustable support beams 34. It is contemplated that multiple sources of pressurized fluid may be interconnected to supply pressurized fluid to system 62.

Each adjustable support beam 32 and adjustable device 56 may include at least one control valve 68 that may function to meter pressurized fluid from source 66 to one of the first and second hydraulic or pneumatic chambers and to allow fluid from the other of the first and second chambers to drain to tank 64. Specifically, control valve 68 may include a spring biased valve mechanism that is solenoid actuated and configured to move between a first position at which fluid is allowed to flow into one of the first and second chambers and a second position at which fluid flow is drained from the other of the first and second chambers. The location of the valve mechanism between the first and second positions may determine a flow rate of the pressurized fluid directed into and out of the associated first and second chambers. The valve mechanism may be movable between the first and second positions in response to a demanded flow rate that may produce a desired upward or downward movement of conveyor system 30. It is contemplated that control valve 68 may alternately be hydraulically actuated, mechanically actuated, pneumatically actuated, or actuated in any other suitable manner.

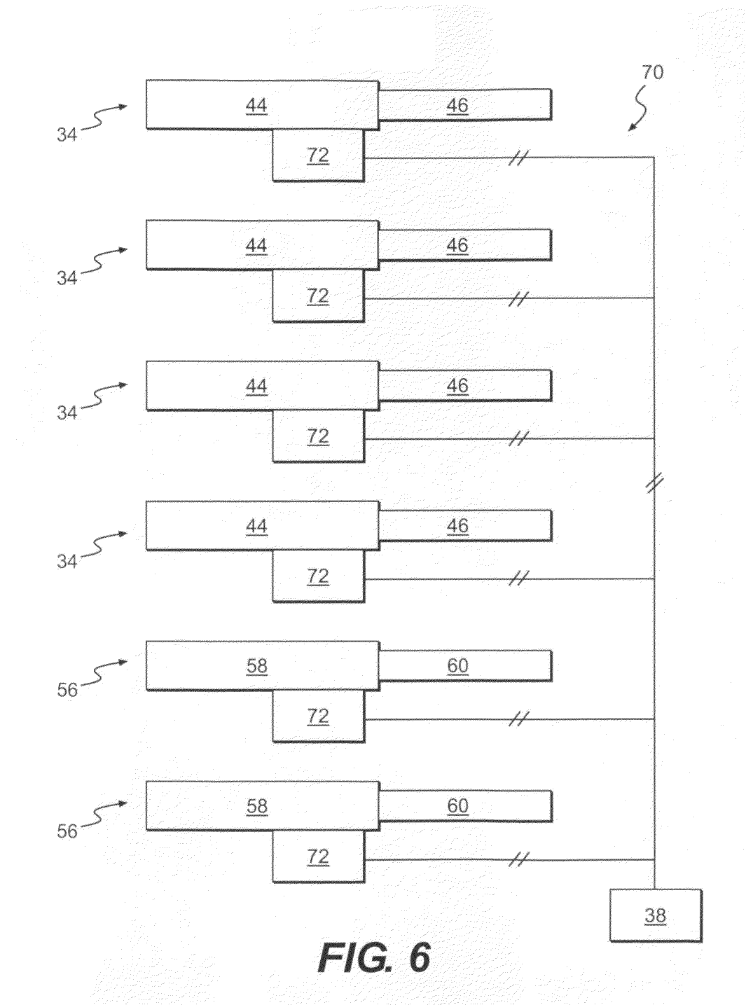

FIG. 6 illustrates yet another embodiment of modular manufacturing unit 12 where an exemplary electric motor system 70 may be used adjust the height of conveyor system 30. Electric motor system 70 may include a plurality of electric motors 72 operationally connected to each adjustable support beam 32 and adjustable device 56, with each motor 72 being configured to linearly expand and contract adjustable support beams 32 and adjustable devices 56. Electric motors 72 may be AC induction motors, brushless DC motors, linear motors, or any other type of motor capable of linearly moving piston portions 46 in and out of tubular portion 44 and/or moving piston portions 60 in and out of tubular portions 58. Additionally, electric motors 72 may be directly powered by utility source 38 via electrical wires running along the interior of fixed support beams 32 and along the exterior of adjustable support beams 34.

Referring back to FIGS. 3 and 4, conveyor portion 52 may be suspended from structural portion 50. Conveyor portion 52 may be any type of article transport system such as, for example, the friction drive system illustrated in FIGS. 3 and 4, an air balancer, a series of hoists, an electrified monorail, or any device capable of moving an article from module to module. The exemplary conveyor portion 52 illustrated in FIGS. 3 and 4 may include a support portion 74, a propulsion portion 76, and a conveying portion 78.

Support portion 74 may provide structural support to the elements of conveyor portion 52 and articles being conveyed. In addition, support portion 74 may include an upper beam 80, lower beams 82, and connection devices 84. Upper beam 80 may be directly connected to adjustable devices 56 of structural portion 50 via any device such as, for example, welds, mechanical fasteners, or any other devices capable of adequately securing upper beam 80 to support portion 50. In addition, lower beams 82 may provide platforms along which the elements of article support portion 74 may travel. Lower beams 82 may be secured to upper beam 80 via connection devices 84. Connection devices 84 may maintain a predetermined distance between upper and lower beams 80, 82 in which propulsion portion 76 and some of the elements of conveying portion 78 may be installed. Connecting devices 84 may be any device such as, for example, rods, or any other device that may maintain a space between upper and lower beams 80, 82. It is contemplated that upper beam 80, lower beam 82, and connection devices 84 may be fabricated from steel, carbon composites, or any other material known in the art suitable for supporting articles being transported by conveyor portion 52.

Propulsion portion 76 may generate power which may be used by conveying portion 78 to transport articles through modular manufacturing unit 12. Propulsion portion 76 may include a motor 86 for rotatably driving a cylinder 88. Motor 86 may be secured to upper beam 80 and may be any type of motor such as, for example, AC induction motors, brushless DC motors, or any other type of motor capable of rotatably driving cylinder 88. In addition, cylinder 88 may be rotatably secured to upper beam 80 via a plurality of bearing devices 90, which may permit cylinder 88 to freely rotate around a longitudinal axis (not shown). Furthermore, motor 86 may be operationally connected to cylinder 88 via a transmission device 92. Transmission device 92 may translate the power generated by motor 86 to a rotational movement of cylinder 88 and may be any device capable of transferring the power generated by motor 86 to cylinder 88 such as, for example, a band, a chain, etc. It should be understood that because each modular manufacturing unit 12 may have its own motor 86, each cylinder 88 may be rotated at a speed that may be unique to the associated modular manufacturing unit 12. Therefore, articles being transported through different modular manufacturing units 12 may move at different speeds, if desired.

Conveying portion 78 may support and move articles through modular manufacturing unit 12. In addition, conveying portion 78 may include a trolley 94 for laterally moving articles through modular manufacturing unit 12 and an article carrying device 96. Trolley 94 may include a central body 98 and a plurality of wheels 100 rotatably connected to central body 98. An upper set of wheels 100 may contact cylinder 88 and may be situated so that the rotational motion of cylinder 88 may cause the upper set of wheel 100 to rotate and move trolley 94 forward along the length of conveyor system 30. A lower set of wheels 100 may contact lower beams 82 providing support for trolley 94 as trolley 94 may move along the length of conveyor system 30. In addition, article carrying device 96 may include a supporting device 102 to which gripping devices (not shown) may be attached. Supporting device 102 may include any device such as, for example, a load bar or any other device capable of supporting one or more articles. In addition, the gripping devices may grip the article to be conveyed through the manufacturing chain and may include, for example, a hook, a clamp, a latch or any other device capable of temporarily grasping the article. Furthermore, supporting device 102 may be connected to trolley 94 via a connecting device 104. Connecting device 104 may be any device such as, for example, a hook, a clamp, a latch or any other device capable of connecting supporting device 102 to trolley 94.

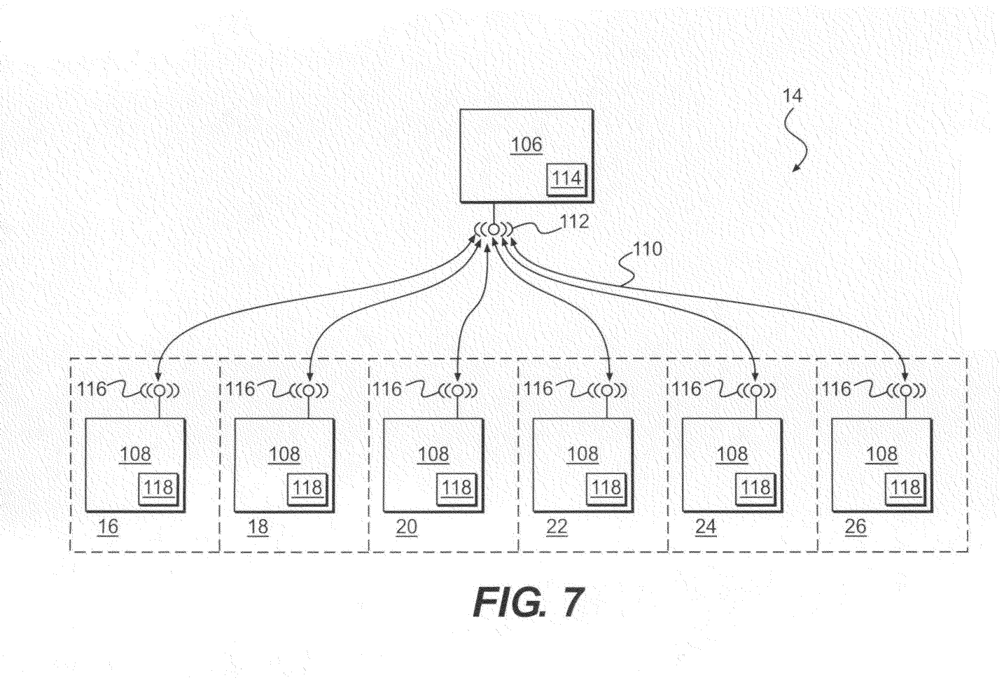

As illustrated in FIG. 7, control system 14 may control the various systems of manufacturing chain 10. For example, control system 14 may select a height from a plurality of heights at which each conveyor system 30 may operate. Conveyor system heights may be selected based on manufacturing processes performed by the associated modular manufacturing unit 12, the height of conveyor systems 30 of adjacent modular manufacturing units 12, or any other suitable factor. It should be understood that at locations where conveyors systems 30 communicate with each other, the height of conveyor systems 30 may need to be substantially the same so that articles may be adequately transported from one modular manufacturing unit 12 to the other. However, the portions of conveyor systems 30 located away from other conveyor systems 30 may be set to unique heights. Control system 14 may also select a speed at which each conveyor system 30 may transport articles from a plurality of speeds. The speeds may be selected based on manufacturing processes performed by the associated modular manufacturing unit 12, manufacturing processes being performed by adjacent modular manufacturing units 12, or any other suitable factor.

Control system 14 may include a master controller 106 and one or more slave controllers 108 that may communicate with each other over a wireless communication network 110. Wireless communication network 110 may include any network that provides two-way communication between master and slave controllers 106, 108 across one or more broadband communication platforms appropriate for communicatively coupling master and slave controllers 106, 108. Such platforms may include, for example, cellular, Bluetooth, microwave, point-to-point wireless, point-to-multipoint wireless, multipoint-to-multipoint wireless, or any other appropriate communication platform for networking a number of components. Alternatively and/or additionally, communication network 16 may include a satellite communication system and/or a local area network. It is contemplated that, in an alternate embodiment, master controller 106 may be omitted and that one of slave controllers 108 may assume the role of a master controller. It is further contemplated that in another alternate embodiment, slave controllers 108 may be omitted and master controller 106 alone may regulate the processes of manufacturing chain 10.

Master controller 106 may coordinate the processes of manufacturing chain 10 and may embody a computer based system, a microprocessor based system, a microcontroller, or any other suitable control type circuit or system. In addition, master controller 106 may include various components for running software applications designed to regulate and coordinate the processes of manufacturing chain 10. For example, master controller 106 may include a central processing unit (CPU), a random access memory (RAM), input/output (I/O) elements, etc. Furthermore, master controller 106 may be located remotely from or adjacent to manufacturing chain 10, as desired.

Master controller 106 may receive input from slave controllers 108 via a communication device 112 and/or from an operator via an operator input device 114 and may regulate the operation of the various systems of manufacturing chain 10 in response to the input. Communication device 112 may be any device capable of receiving and sending data such as, for example, a transceiver. In addition, operator interface device 114 may be a touch screen, keyboard, control panel, or any other device capable of facilitating communication between the operator and control master controller 106.

Each slave controller 108 may be associated with a modular manufacturing unit 12 and may coordinate the processes of the associated modular manufacturing unit 12. Each slave controller 108 may embody a computer based system, a microprocessor based system, a microcontroller, or any other suitable control type circuit or system. In addition, each slave controller 108 may include various components for running software applications designed to regulate and coordinate the processes of the associated modular manufacturing unit 12. For example, each slave controller 108 may include a central processing unit (CPU), a random access memory (RAM), input/output (I/O) elements, etc. Furthermore, each slave controller 108 may be located anywhere within the associated modular manufacturing unit 12, as desired.

Each slave controller 108 may receive input from other slave controllers 108 and/or master controller 106 via a communication device 116 and/or from an operator via an operator input device 118 and may regulate the operation of the various systems of the associated modular manufacturing unit 12 in response to the input. Communication device 116 may be any device capable of receiving and sending data such as, for example, a transceiver. In addition, operator interface device 118 may be a touch screen, keyboard, control panel, or any other device capable of facilitating communication between the operator and slave controller 108. It is contemplated that slave controllers 108 may regulate the processes of the associated modular manufacturing unit 12 independent of master controller 106, if desired.

### INDUSTRIAL APPLICABILITY

The disclosed manufacturing system may provide portability and flexibility to a manufacturing process, by utilizing individual portable modules having adjustable article conveyor systems. The adjustable article conveyors may operate at a variety of speeds and heights, which may permit the performance of a wide variety manufacturing processes by a particular manufacturing chain. In addition, by utilizing a modular strategy, the manufacturing system may be easily and quickly modified to address changes in consumer demand.

Utilizing article conveyor systems integrated with the frames of the portable manufacturing modules may increase the flexibility of the manufacturing chain. In particular, such article conveying systems may permit articles to be transported between modules without being stacked on top of each other, thereby minimally affecting any coating applied to the surfaces of the articles being conveyed. Furthermore, the articles conveying systems may utilize many types of article carrying devices in addition to magazine units, thereby increasing the variety of articles that may be transported through manufacturing chain 10.

It will be apparent to those skilled in the art that various modifications and variations can be made in the disclosed system without departing from the scope of the disclosure. Other embodiments will be apparent to those skilled in the art from consideration of the specification disclosed herein. It is intended that the specification and examples be considered as exemplary only, with a true scope being indicated by the following claims and their equivalents.

What is claimed is:

1. A modular manufacturing station, comprising:
a plurality of beams forming a skeleton;
an article transportation system configured to transport one or more articles through the manufacturing station at a speed selected from a plurality of speeds and at a height selected from a plurality of heights;
at least one utility connection for receiving external utilities;
at least one piece of manufacturing equipment; and
a controller configured to regulate the speed and height at which articles are transported through the modular manufacturing station and regulate the operation of the manufacturing equipment.

2. The modular manufacturing station of claim 1, wherein the article transportation system has a structural portion secured to the skeleton and a conveyor portion suspended from the structural portion via one or more expansion/contraction devices.

3. The modular manufacturing station of claim 2, wherein the height of the conveyor portion is greater when the one or more contraction/expansion devices are contracted and is lower when the one or more expansion/contraction devices are expanded.

4. The modular manufacturing station of claim 3, further including one of a hydraulic system, pneumatic system, or an electric motor system utilized to expand and contract the one or more expansion/contraction devices.

5. The modular manufacturing station of claim 1, wherein one or more beams are expansion/contraction beams configured to expand and contract.

6. The modular manufacturing station of claim 5, wherein the height of the conveyor system is greater when the one or more expansion/contraction beams are expanded and is lower when the one or more expansion/contraction beams are contracted.

7. The modular manufacturing station of claim 6, further including one of a hydraulic system, pneumatic system, or electric motor system utilized to expand and contract the one or more expansion/contraction beams.

8. The modular manufacturing station of claim 1, wherein the controller is in communication with other controllers associated with other modular manufacturing units.

9. The modular manufacturing station of claim 8, wherein the controller is configured to regulate the speed and height at which articles are transported through the modular manufacturing station and regulate the operation of the manufacturing equipment in response to input from one or more of the other controllers.

10. A method for operating an article transportation system of a modular manufacturing station, comprising:
selecting a height at which articles are transported through the modular manufacturing station from a plurality of heights;
adjusting the height of the article transportation system so that articles are transported through the modular manufacturing station at substantially the same height as the selected height;
selecting a speed at which articles are transported through the modular manufacturing station from a plurality of speeds; and
adjusting the speed of the article transportation system so that articles are transported through the modular manufacturing station at substantially the same speed as the selected speed.

11. The method of claim 10, wherein adjusting the height of the article transportation system includes actuating one or more expansion/contraction devices connected to the article transportation system.

12. The method of claim 11, wherein adjusting the height of the article transportation system further includes actuating a hydraulic system, pneumatic system, or an electric motor system.

13. The method of claim 10, wherein adjusting the height of the article transportation system includes expanding or contracting a frame of the modular manufacturing station.

14. The method of claim 13, wherein adjusting the height of the article transportation system further includes actuating a hydraulic system, pneumatic system, or an electric motor system.

15. A manufacturing chain comprising:
a first modular manufacturing station, including:
a plurality of beams forming a skeleton;
an article transportation system configured to transport one or more articles through the manufacturing station at a speed selected from a plurality of speeds and at a height selected from a plurality of heights;
at least one utility connection for receiving external utilities; and
at least one piece of manufacturing equipment;
a second modular manufacturing station, including:
a plurality of beams forming a skeleton;
an article transportation system configured to transport one or more articles through the manufacturing station at a speed selected from a plurality of speeds and at a height selected from a plurality of heights;
at least one utility connection for receiving external utilities; and
at least one piece of manufacturing equipment; and
a control system, including:
at least one controller configured to regulate the speed and height at which articles are transported through the modular manufacturing stations of the manufacturing chain and regulate the operation of the manufacturing equipment associated with the modular manufacturing stations of the manufacturing chain.

16. The manufacturing chain of claim 15, wherein the control system further includes a first controller configured to regulate the speed and height at which articles are transported through the first modular manufacturing station and regulate the operation of the manufacturing equipment associated with the first modular manufacturing station and a second controller configured to regulate the speed and height at which articles are transported through the second modular manufacturing station and regulate the operation of the manufacturing equipment associated with the second modular manufacturing station, one of the controllers of the control system being a master controller having operational control over the rest of the control system.

17. The manufacturing chain of claim 15, wherein the control system further includes a first controller configured to regulate the speed and height at which articles are transported through the first modular manufacturing station and regulate the operation of the manufacturing equipment associated with the first modular manufacturing station, a second controller configured to regulate the speed and height at which articles are transported through the second modular manufacturing station and regulate the operation of the manufacturing equipment associated with the second modular manufacturing station, and a master controller having operational control over the whole control system.

18. The manufacturing chain of claim 17, wherein the control system is configured to regulate the speeds of the article transportation systems so that articles are transported through each modular manufacturing station at a unique speed.

19. The manufacturing chain of claim 18, wherein the control system is configured to regulate the heights of the article transportation systems so that articles are transported through each modular manufacturing station at a unique height.

20. The manufacturing chain of claim 15, wherein each modular manufacturing station further includes a hydraulic, pneumatic, or electric motor system utilized to adjust the height of the article transportation system associated with the modular manufacturing station.
